(19) United States
(12) Patent Application Publication
(10) Pub. No.: US 2016/0373909 A1
(43) Pub. Date: Dec. 22, 2016

(54) WIRELESS AUDIO, SECURITY COMMUNICATION AND HOME AUTOMATION

(71) Applicant: Hive Life, LLC, Farmington, UT (US)

(72) Inventors: Chad Rasmussen, West Valley City, UT (US); Brandon John, Farmington, UT (US)

(73) Assignee: Hive Life, LLC, Farmington, UT (US)

(21) Appl. No.: 15/186,317

(22) Filed: Jun. 17, 2016

Related U.S. Application Data
(60) Provisional application No. 62/181,095, filed on Jun. 17, 2015.

(51) Int. Cl. H04W 4/22; H04L 12/24; H04W 40/00; G10L 17/22; H04W 4/04; G10L 13/02; G06F 3/16; H04W 4/00; H04L 29/06

(52) U.S. Cl. CPC H04W 4/22; H04W 4/008; H04W 4/003; H04L 41/0681; H04L 41/0631; H04W 40/005; H04L 69/22; H04W 4/043; G10L 13/02; G06F 3/165; G10L 17/22; H04W 84/12

(57) ABSTRACT

A device comprising includes a housing and a plug adapter configured to engage a wall outlet to receive power from the wall outlet and retain the device against a wall with respect to the wall outlet. The device includes one or more speakers, one or more wireless transceivers for communicating over a wireless network, and one or more microphones. The device also includes an audio processing device and a processing unit. The audio processing device is configured to receive audio from the one or more microphones and detect voice commands. The processing unit is configured to, in response to the voice commands, trigger one or more of audio playback and a two-way voice call.

### BACKGROUND

Home entertainment, security, and automation systems provide a wide array of convenient features for residents. Often, installation and/or configuration of such systems require complex installation or set up procedures that require skilled technicians.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1 illustrates a schematic of a home security, automation, and/or entertainment system in accordance with one embodiment of the teachings and principles of the disclosure;

FIG. 2 is a schematic diagram illustrating another home security, automation, and/or entertainment system in accordance with one embodiment of the teachings and principles of the disclosure;

FIG. 3 is a schematic diagram illustrating yet another home security, automation, and/or entertainment system in accordance with one embodiment of the teachings and principles of the disclosure;

FIG. 4 illustrates an overhead view of a home having a home security, automation, and/or entertainment system in accordance with one embodiment of the teachings and principles of the disclosure;

FIG. 5 illustrates a block diagram of example computing components in accordance with one embodiment of the teachings and principles of the disclosure;

FIG. 6 illustrates an example embodiment of a hub in accordance with one embodiment of the teachings and principles of the disclosure;

FIG. 7 illustrates an implementation of an example embodiment of a sound beacon in accordance with one embodiment of the teachings and principles of the disclosure;

FIG. 8 illustrates a front view an example embodiment of a sound beacon in accordance with one embodiment of the teachings and principles of the disclosure;

FIG. 9 illustrates front, side, and rear views of an example embodiment of a sound beacon in accordance with one embodiment of the teachings and principles of the disclosure;

FIG. 10 illustrates an embodiment of a sound beacon with dock in accordance with one embodiment of the teachings and principles of the disclosure;

FIG. 11 illustrates an implementation of a method for providing home security, entertainment, and communication in accordance with one embodiment of the teachings and principles of the disclosure;

FIG. 12 illustrates an example embodiment of a faceplate with a built in hub in accordance with one embodiment of the teachings and principles of the disclosure;

FIG. 13 illustrates a block diagram of components of a faceplate hub in accordance with one embodiment of the teachings and principles of the disclosure;

FIG. 14 illustrates a block diagram of components of a sound beacon in accordance with one embodiment of the teachings and principles of the disclosure; and

FIG. 15 illustrates a block diagram of components of a two-way emergency call in accordance with one embodiment of the teachings and principles of the disclosure; and

FIG. 16 illustrates a block diagram of lighting provided by a sound beacon in accordance with one embodiment of the teachings and principles of the disclosure.

### DETAILED DESCRIPTION

With the increased desire for home entertainment, security, and automation systems driven by wireless technologies, Applicants have recognized that it is important to use the advances in technology and communication systems to provide products that can streamline these devices into a system and that can be used as a new system or to retrofit an existing home, business or other structure or dwelling with such devices. Applicants have developed methods, systems, and computer program implemented products for providing home entertainment, two-way communication, security, and automation systems driven by wireless technologies that can be streamlined and used as a new system or as a retrofitted system for an existing home, business or other structure or dwelling.

The present disclosure extends to devices, systems, methods and computer program products relating to home entertainment, two-way communication, security, and automation systems driven by wireless technologies. In the following description of the disclosure, reference is made to the accompanying drawings, which form a part hereof, and in which is shown by way of illustration specific implementations in which the disclosure may be practiced. It is to be understood that other implementations may be utilized and structural changes may be made without departing from the scope of the disclosure.

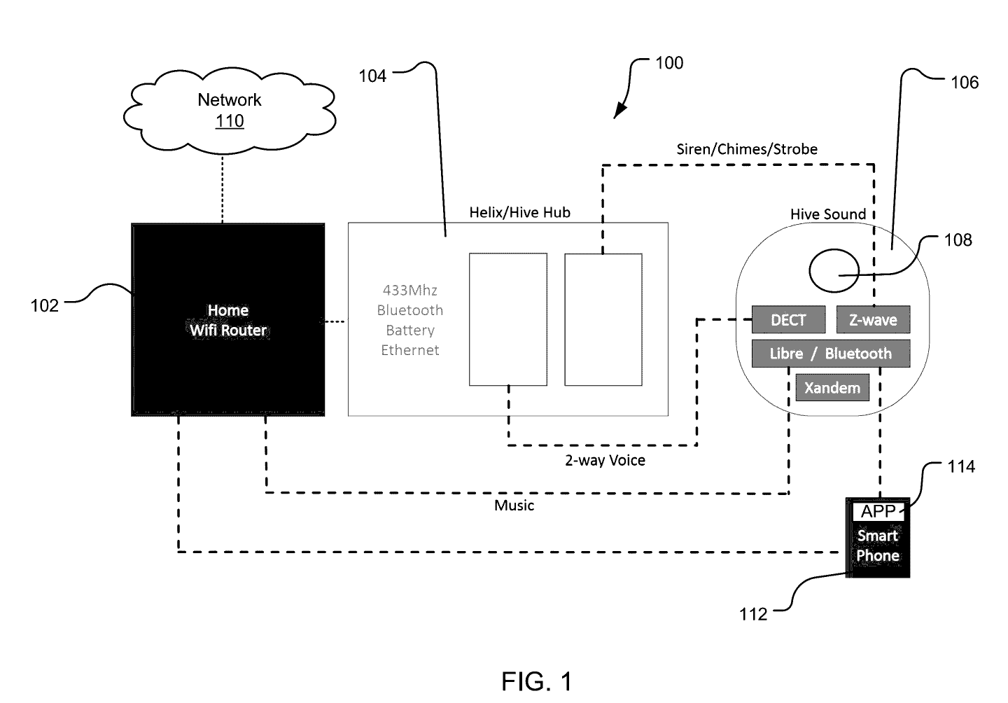

FIG. 1 illustrates a schematic diagram of an embodiment of a home entertainment, intercom, security, and automation system driven by wireless technologies. As illustrated in the figure, a home system 100 may include a home network router or node 102 (WiFi) that may be connected to the internet 110, a hub 104, and/or a sound beacon 106. Additionally, a user may access the home system 100 wirelessly through a mobile device 112 running an app 114. A mobile device 112 may include any electronic device that is capable of receiving inputs from a user and outputting prompts to the user. Example mobile devices 112 include phones, tablets, mobile computers, remotes, dedicated entertainment or security controllers, etc.

In an implementation of the home system 10, the hub 104 may provide connectivity to and from peripheral devices both wirelessly and hard wired such as desktop computers, televisions, existing audio and lighting systems. The hub 104 may include or implement such wireless technologies as: Bluetooth, global system for mobile communications (GSM), digital enhanced cordless communication (DECT), Z-Wave, WiFi, etc. Additionally, the hub 104 may include a port for wired or wireless Ethernet connections and may include a battery to provide functionality in case of power failure.

In an implementation of the home system 100 having a sound beacon 106, the sound beacon 106 may have at least one speaker 108, and may be configured to be plugged directly into a wall power socket and may include a battery so as to be at least partially operable during a power outage. The sound beacon 106 may include wireless components such as a DECT radio for two-way voice communication, and other radios for music transmission, communication, motion detection, location detection, or other communications or coordination between devices. For example, communication radios or controllers may include chips provided by or operating according to WiFi, Libre®, Bluetooth®, and/or Xandem® standards or protocols. Additionally, the sound beacon 106 may include wireless components for the Z-Wave protocol and may include security functionalities such as siren, chime, and strobe which may be activated in response to detection of an intruder or other event.

In an implementation a hub 104 may communicate through the Z-Wave protocol with a sound beacon 106 in order to provide security type alerts that are common with prior art security systems. Hubs or controllers from any manufacturer may be used. For example, controllers for alarm systems may interface with the sound beacon 106 whether or not the hub 104 is available or even part of the home system 100.

In an implementation a hub 104 may communicate through the DECT protocol with a sound beacon 106 in order to provide two-way voice communications that are available with existing or third-party intercom systems.

In an implementation a WiFi home router 102 may communicate wirelessly with a sound beacon 106 in order to provide music in to the home through a speaker 108. Additionally, a plurality of sound beacons 106 may be used simultaneously, and during such simultaneous use, may modify music play back relative to the location of other sound beacons that have been installed.

In an implementation, a plurality of sound beacons 106 may be configured to work in concert and may act as signal repeaters for the wireless signals that they are each receiving, thereby extending the range of the wireless signals used by the home system 100.

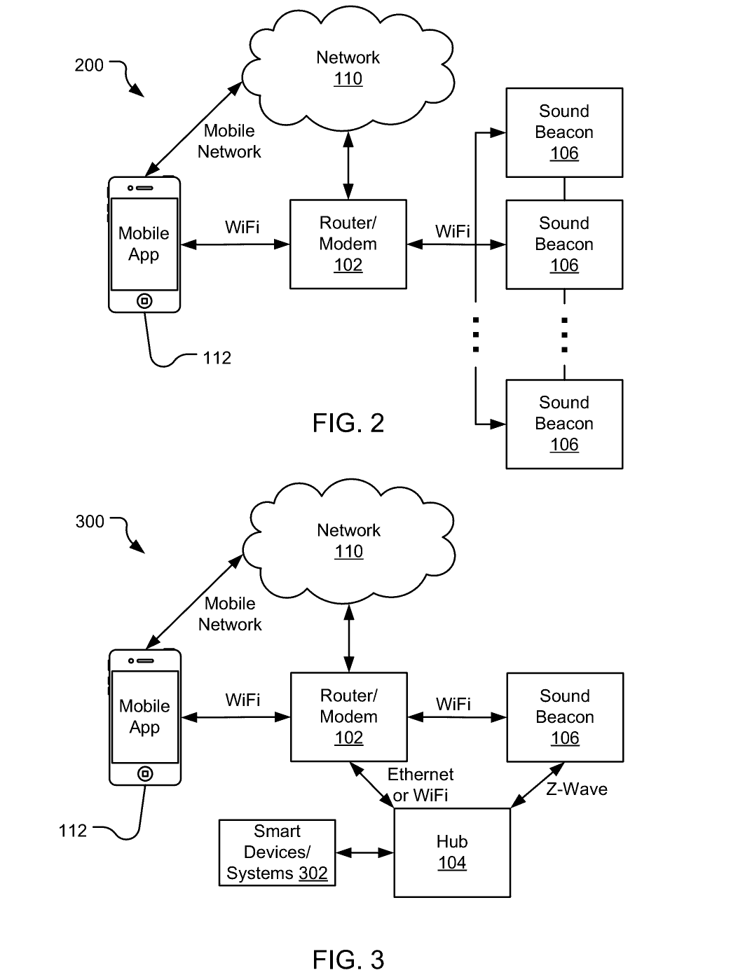

FIG. 2 is a schematic diagram illustrating another example implementation of a home system 200. The home system 200 includes a router/modem 102 and one or more sound beacons 106. A mobile device 112 running a mobile app may interface with or control the sound beacons 106 via the router/modem 102 and/or a network/cloud 110. For example, the mobile device 112 may provide music for streaming or other instructions to configure or control operation of one or more sound beacons 106. In the home system 200 of FIG. 2, no hub, controller, alarm panel, or the like is necessary in order to control or use the sound beacon 106. For example, the sound beacon 106 can connect to the cloud and/or mobile device 112 for content and/or operating instructions. Additionally, the sound beacons 106 may communicate directly with each other to forward messages or provide control. For example, one of the sound beacons 106 may be designated or may operate as a master that then controls operation of the other sound beacons 106.

FIG. 3 is a schematic diagram illustrating another example implementation of a home system 300. The home system 300 includes a router/modem 102, a hub 104, one or more sound beacons 106, and one or more smart devices/systems 302. A mobile device 112 running a mobile app may interface with or control the sound beacons 106, the hub 104, and/or the smart devices/systems 302 via the router/modem 102 and/or a network/cloud 110. For example, the mobile device 112 may provide music for streaming or other instructions to configure or control operation of one or more sound beacons 106, the hub 104 and/or smart devices/systems 302. The smart devices/systems 302 may include sensors or device which can communicate with the hub 104. For example, the smart devices/systems 302 may include lighting, alarm, entertainment, HVAC/thermostat, or other devices/systems that are controlled by the hub 104 via a wired or wireless (e.g., Z-Wave) interface. With the presence of the hub 104, the sound beacon 106 may operate, at least in part, as a Z-Wave slave device. For example, the sound beacon 106 may receive instructions and commands via Z-Wave that then trigger operations by the sound beacon. Additionally, sound beacons 106 may communicate directly with each other to forward messages or provide control. For example, one of the sound beacons 106 may be designated or may operate as a master that then controls operation of the other sound beacons 106.

In one embodiment, the hub 104 may include a controller or hub from a third party manufacturer or company. For example, the hub 104 may include an alarm panel controller that controls an alarm system. The hub 104 may have a mobile network connection and may be controlled or configured using a mobile app on a mobile device 112. In one embodiment, the mobile device 112 may include a first app for interfacing with the hub 104 and a second, different app for interfacing with the sound beacon 106. For example, the second app may be sued for interfacing with sound beacons 106 in a manner discussed in relation to FIG. 2 and the first app may interface with the hub 104. Thus, the sound beacon 106 may receive instructions from different controllers or systems and process those methods accordingly to provide entertainment, security, communication, or other services.

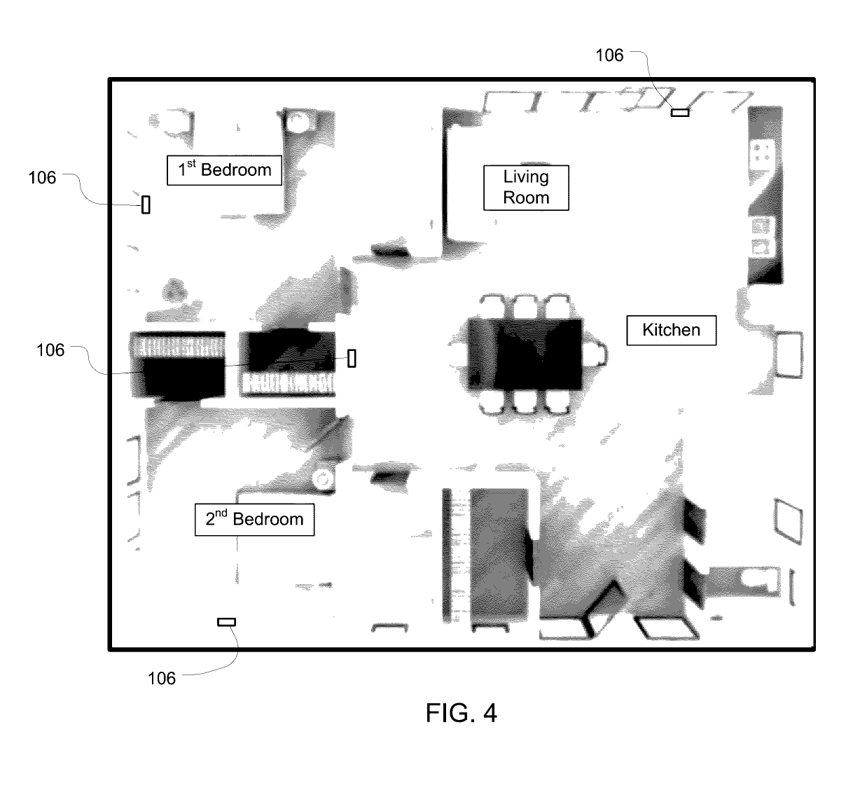

FIG. 4 illustrates an overhead view of an example home layout where a home system, such as the home systems 100, 200, or 300 of FIGS. 1-3, may be deployed. As can be seen in the figure, the home layout has been divided into a plurality of rooms or zones (1^{st} bedroom, 2^{nd} bedroom, living room, and kitchen), wherein each zone may have one or more sound beacons 106. For example, the figure is illustrated as having many room or zones, but it will be appreciated that any number of zones may be implemented, wherein rooms may have a plurality of zones within the same room, multiple rooms may fall within the same zone, and/or some rooms or may have no zones or sound beacon 106. It will be appreciated that the number of zones may be determined based on a number of factors, including, ceiling height, ceiling type, wall material, etc. which will help determine the configuration of the sound beacon 106 that is needed for each zone. It will be appreciated that the sound beacon 106 and its zonal capacity, in terms of sound output, microphone sensitivity, and/or wireless communication range, may determine the number of zones that may be needed for complete coverage of a home.

In an implementation, each zone may have different audio needs and limitations. Each zone may be associated with a certain sound beacon 106 that allows sound to fill each area properly. As can be seen in the figure, a zone may be a kitchen, a living room, a bedroom, a carpeted area, a high ceiling area, or any combination of the above.

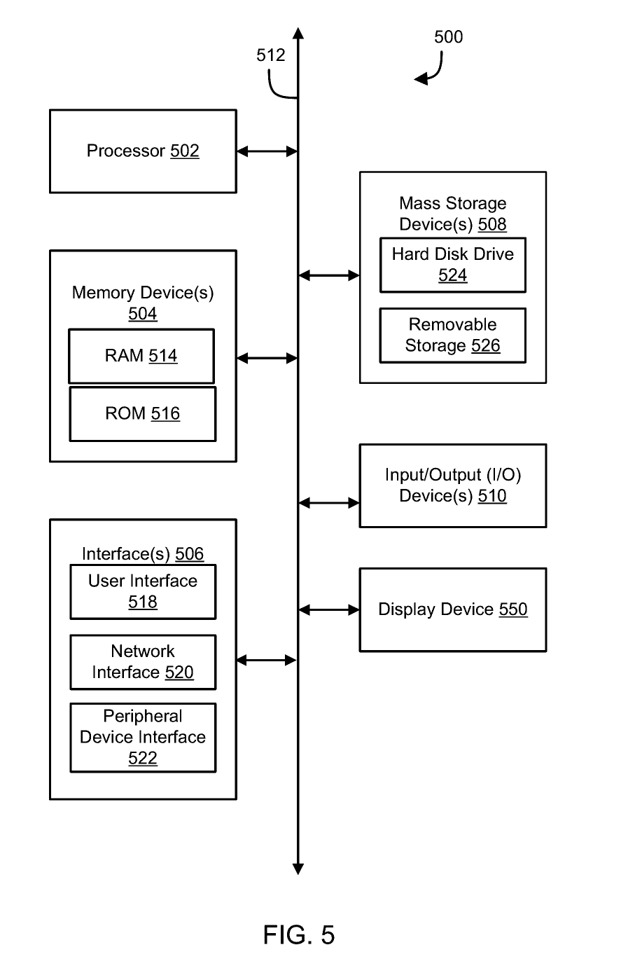

FIG. 5 illustrates a schematic diagram of a computing system 500. The computing system 500 may be used as one or more components of a home system. For example, a hub 104 or sound beacon 106 may include a computing system with a similar configuration as the computing system 500. A home system and its electronic components may communicate over a network wherein the various components are in wired and wireless communication with each other and the internet. It will be appreciated that implementations of the disclosure may include or utilize a special purpose or general-purpose computer, including computer hardware, such as, for example, one or more processors and system memory as discussed in greater detail below. Implementations within the scope of the disclosure also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can include at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice-versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid-state drives (SSDs or PCIx based real time memory tiered storage, such as FusionIO). Thus, it should be understood that computer storage media (devices) can be included in computer system components that also (or even primarily) utilize transmission media.

Computer-executable instructions include, for example, instructions and data, which, when executed at a processor, cause a general purpose computer, special purpose computer, or special purpose processing device to perform a certain function or group of functions. The computer executable instructions may be, for example, binaries, intermediate format instructions such as assembly language, or even source code.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, commodity hardware, commodity computers, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the disclosure can also be used in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, or any suitable characteristic now known to those of ordinary skill in the field, or later discovered), service models (e.g., Software as a Service (SaaS), Platform as a Service (PaaS), Infrastructure as a Service (IaaS)), and deployment models (e.g., private cloud, community cloud, public cloud, hybrid cloud, or any suitable service type model now known to those of ordinary skill in the field, or later discovered). Databases and servers described with respect to the disclosure can be included in a cloud model.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and claims to refer to particular system components. As one skilled in the art will appreciate, components may be referred to by different names. This document does not intend to distinguish between components that differ in name, but not function.

Referring again to FIG. 5, a block diagram of an example computing device 500 is illustrated. Computing device 500 may be used to perform various procedures, such as those discussed herein. Computing device 500 can function as a server, a client, or any other computing entity. Computing device 500 can perform various monitoring functions as discussed herein, and can execute one or more application programs, such as the application programs described herein. Computing device 500 can be any of a wide variety of computing devices, such as a desktop computer, a notebook computer, a server computer, a handheld computer, tablet computer and the like. In one embodiment, the computing device 500 is a specialized computing device based on programs, code, computer readable media, sensors, or other hardware or software configuring the computing device 500 for specialized functions and procedures.

Computing device 500 includes one or more processor(s) 502, one or more memory device(s) 504, one or more interface(s) 506, one or more mass storage device(s) 508, one or more Input/Output (I/O) device(s) 510, and a display device 950 all of which are coupled to a bus 512. Processor(s) 502 include one or more processors or controllers that execute instructions stored in memory device(s) 504 and/or mass storage device(s) 508. Processor(s) 502 may also include various types of computer-readable media, such as cache memory.

Memory device(s) 504 include various computer-readable media, such as volatile memory (e.g., random access memory (RAM) 514) and/or nonvolatile memory (e.g., read-only memory (ROM) 516). Memory device(s) 504 may also include rewritable ROM, such as Flash memory.

Mass storage device(s) 508 include various computer readable media, such as magnetic tapes, magnetic disks, optical disks, solid-state memory (e.g., Flash memory), and so forth. As shown in FIG. 5, a particular mass storage device is a hard disk drive 524. Various drives may also be included in mass storage device(s) 508 to enable reading from and/or writing to the various computer readable media. Mass storage device(s) 508 include removable media 526 and/or non-removable media.

I/O device(s) 5100 include various devices that allow data and/or other information to be input to or retrieved from computing device 500. Example I/O device(s) 5100 include cursor control devices, keyboards, keypads, cameras, microphones, monitors or other display devices, speakers, printers, network interface cards, modems, and the like.

Display device 550 includes any type of device capable of displaying information to one or more users of computing device 500. Examples of display device 550 include a monitor, display terminal, video projection device, and the like.

Interface(s) 506 include various interfaces that allow computing device 500 to interact with other systems, devices, or computing environments. Example interface(s) 506 may include any number of different network interfaces 520, such as interfaces to local area networks (LANs), wide area networks (WANs), wireless networks (disclosed in more detail below), and the Internet. Other interface(s) include user interface 518 and peripheral device interface 522. The interface(s) 506 may also include one or more user interface elements 518. The interface(s) 506 may also include one or more peripheral interfaces such as interfaces for printers, pointing devices (mice, track pad, or any suitable user interface now known to those of ordinary skill in the field, or later discovered), keyboards, and the like.

Bus 512 allows processor(s) 502, memory device(s) 504, interface(s) 506, mass storage device(s) 508, and I/O device(s) 5100 to communicate with one another, as well as other devices or components coupled to bus 512. Bus 512 represents one or more of several types of bus structures, such as a system bus, PCI bus, IEEE 1594 bus, USB bus, and so forth.

For purposes of illustration, programs and other executable program components are shown herein as discrete blocks, although it is understood that such programs and components may reside at various times in different storage components of computing device 500, and are executed by processor(s) 502. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

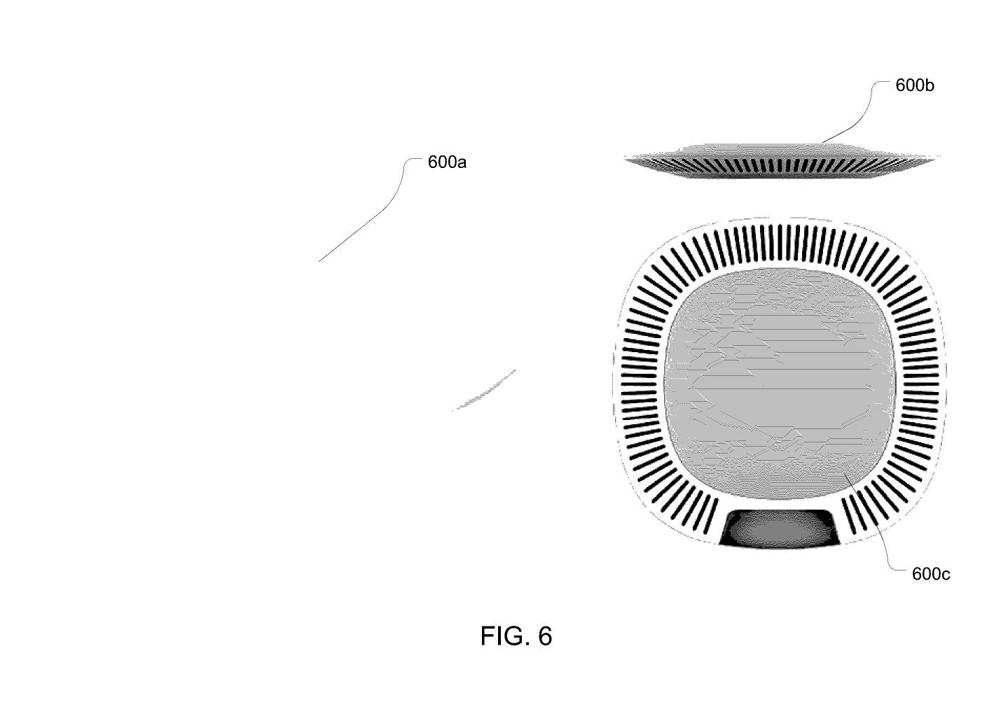

FIG. 6 illustrates an embodiment of an example hub from a perspective view 600a, side view 600b, and top view 600c. In an implementation of the home system 10, the hub 104 may provide connectivity to and from peripheral devices both wirelessly and hard wired such as desktop computers, televisions, existing audio and lighting systems. The hub 104 may include such wireless technologies as: Bluetooth, GSM, DECT, Z-Wave, WiFi, etc. Additionally, the hub 104 may include one or more ports for Ethernet connections and may include a battery to provide functionality in case of power failure. In one embodiment, the hub 104 includes processing circuitry and/or a control component to control operation of one or more sound beacons 106, receive or communicate alerts, and/or detect events to trigger procedures or events to be performed by the hub or the sound beacons 106.

In an implementation a hub may communicate through the Z-Wave protocol with a sound beacon 106 in order to provide security type alerts that are common with prior art security systems. In an implementation a hub may communicate through the DECT protocol with a sound beacon 106 in order to provide two-way voice communications that are common with prior art intercom systems. In one embodiment, the hub may provide instructions to one or more sound beacons 106 to play sound. For example, the hub may provide instructions to a sound beacon 106 to play a sound based on determining that a human is present or movement has been detected near the sound beacon 106 or is in a zone corresponding to the sound beacon.

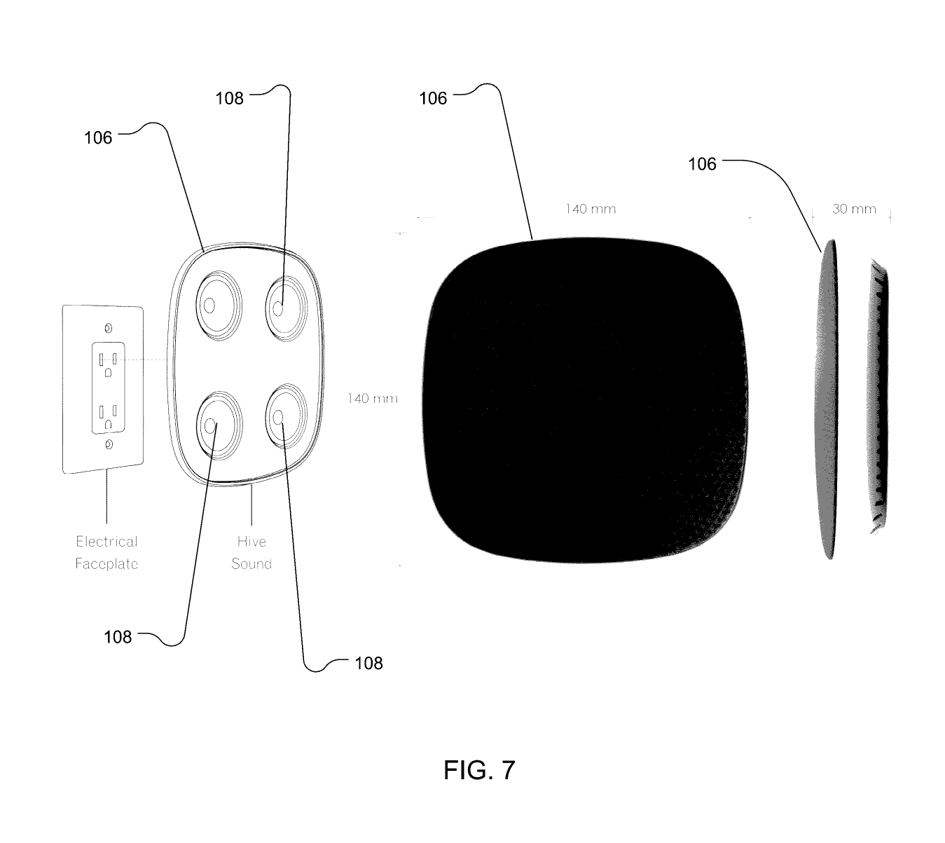

Referring now to FIGS. 5 through 9, one example configuration of the sound beacon 106 is illustrated. The sound beacon 106 may include at least one speaker and other electronic components, including any other components for sound beacons 106 discussed herein.

As illustrated in FIG. 5, the sound beacon 106 may have at least one speaker 108. The at least one speaker 108 may provide for high fidelity sound and the sound beacon 106 may be finely tuned to provide high quality music and audio throughout an entire home, office or other space. The sound beacon 106 may be configured to be plugged directly into a wall power socket. It will be appreciated that the sound beacon 106 may include a battery so as to be operable during a power outage. The sound beacon 106 may include wireless components that provide operability with various wireless standards, such as DECT for two-way voice communication, which may allow for communication with emergency personnel if an emergency need arises. The sound beacon 106 may also include components for music transmission between other sound beacons 106 or with other devices, and may include WiFi, Libre, and/or Bluetooth communication chips. Additionally, the sound beacon 106 may include wireless components for the Z-Wave protocol and may include security functionalities such as siren, chime, and strobe. The sound beacon 106 may further include technology (such as technology from Xandem®) for detecting motion and locating where the motion is currently over an entire floor plan. For example, the hub 104 may receive input derived using tomographic motion detection (TMD) using each of the sound beacons 106 in a floor plan, determine a location of movement, and instruct a sound beacon 106 near the location of movement to play sound at that location. As a user moves throughout a house, such as the floor plan of FIG. 4, different sound beacons 106 may be activated to play sound in a continuous manner so that a user can continue listening to music, participate in a telephone conversation, or receive audio notifications. This may allow sound to only be played at the location of the user so that sound beacons 106 not located near the user do not use energy or processing power to play audio in an empty room.

Regarding two-way voice communication, embodiments may utilize the DECT communication standard. It will be appreciated that other two-way voice communication standards may also be utilized without departing from the scope of the disclosure. However, the DECT standard fully specifies a means for a portable unit, such as a wireless hub 104 or sound beacon 106, to access a fixed telecommunications network via radio. Connectivity to the fixed network (that may be of various different types and kinds) may be done through a base station or a radio fixed part to terminate the radio link, and a gateway to connect calls to the fixed network. In most cases, the gateway connection may be to a public switched telephone network or a telephone jack, although connectivity with newer technologies such as Voice over IP has become available.

The DECT standard may use enterprise premises cordless private automatic branch exchanges (PABXs) and wireless local area networks (LANs) that use many base stations for coverage. Two-way communications may continue as users move between different coverage cells through a mechanism called handover. Calls can be both within the system and to the public telecoms network. Public access uses a plurality of base stations to provide coverage as part of a public telecommunications network.

To facilitate migrations from traditional private branch exchanges (PBXs) to voice over-internet protocol (IP) (VoIP), manufacturers have developed IP-DECT solutions where the backhaul from the base station is via VoIP over Ethernet connection, while communications between base and devices are via DECT. While DECT was originally intended for use with traditional analog telephone networks, DECT bases have higher bit-rates at their disposal than traditional analog telephone networks could provide. DECT-plus-VoIP may also be used. DECT-plus-VoIP has advantages and disadvantages in comparison to VoIP-over-WiFi, where, typically, the devices are directly WiFi+VoIP-enabled, instead of having the DECT-device communicate via an intermediate VoIP-enabled base. On the one hand, VoIP-over-WiFi has a range advantage given sufficient access-points, while a DECT device must remain in proximity to its own base (or repeaters thereof, which in this case may be the sound beacon 106). On the other hand, VoIP-over-WiFi imposes significant design and maintenance complexity to ensure roaming facilities and high quality-of-service.

Interference-free wireless operation for DECT works well, in some embodiments, to around 100 meters or about 1100 yards outdoors, and much less when used indoors if devices are separated by walls. DECT may operate clearly in common congested domestic radio traffic situations, for instance, generally immune to interference from other DECT systems, Wi-Fi networks, video senders, Bluetooth technology, baby monitors and other wireless devices.

Unlike the GSM protocol, the DECT network specifications do not define cross-linkages between the operation of the entities (for example, Mobility Management and Call Control). The architecture presumes that such linkages will be designed into the interworking unit that connects the DECT access network to whatever mobility-enabled fixed network is involved. By keeping the entities separate, the device is capable of responding to any combination of entity traffic, and this creates great flexibility in fixed network design without breaking full interoperability.

The sound beacon 106 may also include components for alarms, alerts, warnings, and notifications relating to environmental and other things happening around the structure. One standard that may be utilized is the Z-Wave technology. Z-Wave communicates using a low-power wireless technology designed specifically for remote control applications. The Z-Wave wireless protocol is optimized for reliable, low-latency communication of small data packets with data rates up to 100 kbit/s, unlike Wi-Fi and other IEEE 802.11-based wireless LAN systems that are designed primarily for high-bandwidth data flow. Z-Wave operates in the sub-gigahertz frequency range, around 900 MHz. This band competes with some cordless telephones and other consumer electronics devices, but avoids interference with Wi-Fi, Bluetooth and other systems that operate on the crowded 2.4 GHz band. Z-Wave is designed to be easily embedded in consumer electronics products, including battery operated devices such as remote controls, smoke alarms and security sensors.

Z-Wave is a protocol oriented to the residential control and automation market. Conceptually, Z-Wave is intended to provide a simple yet reliable method to wirelessly control lights and appliances in a house. To meet these design parameters, the Z-Wave package may include a chip with a low data rate that offers reliable data delivery along with simplicity and flexibility.

Z-Wave works in the industrial, scientific, and medical (ISM) band on a single frequency using frequency-shift keying (FSK) radio. The throughput is up to 100 Kbit/s (9600 bit/s using older series chips) and suitable for control and sensor applications.

Each Z-Wave network may include up to 232 nodes, and consists of two sets of nodes: controllers and slave devices. Nodes may be configured to retransmit the message in order to guarantee connectivity in the multipath environment of a residential house. Average communication range between two nodes is about 30.5 m (about 100 ft.), and with message ability to hop up to four times between nodes, this gives enough coverage for most residential houses and applications.

Z-Wave utilizes a mesh network architecture, and can begin with a single controllable device and a controller. Additional devices can be added at any time, as can multiple controllers, including traditional hand-held controllers, key-fob controllers, wall-switch controllers and PC applications designed for management and control of a Z-Wave network.

It will be appreciated that a device must be “included” to the Z-Wave network before it can be controlled via Z-Wave. This pairing or adding process is usually achieved by pressing a sequence of buttons on the controller and on the device being added to the network. This sequence only needs to be performed once, after which the device is always recognized by the controller. Devices can be removed from the Z-Wave network by a similar process of button strokes.

This inclusion process is repeated for each device in the system. The controller learns the signal strength between the devices during the inclusion process, thus the architecture expects the devices to be in their intended final location before they are added to the system. Typically, the controller has a small internal battery backup, allowing it to be unplugged temporarily and taken to the location of a new device for pairing. The controller is then returned to its normal location and reconnected.

Each Z-Wave network is identified by a Network ID, and each device is further identified by a Node ID. The Network ID is the common identification of all nodes belonging to one logical Z-Wave network. The Network ID has a length of 4 bytes (32 bits) and is assigned to each device, by the primary controller, when the device is paired or included into the Network. It will be appreciated that nodes with different Network ID's cannot communicate with each other.

The Node ID is the address of a single node in the network. The Node ID has a length of 1 byte (8 bits). It is not allowed to have two nodes with identical Node ID on a Network.

Z-Wave uses a source-routed mesh network topology, and has one Primary Controller and zero or more Secondary Controllers that control routing and security. Devices can communicate to one another by using intermediate nodes to actively route around and circumvent household obstacles or radio dead spots that might occur. A message from node A to node C can be successfully delivered even if the two nodes are not within range, providing that a third node B can communicate with nodes A and C. If the preferred route is unavailable, the message originator will attempt other routes until a path is found to the C node. Therefore, a Z-Wave network can span much farther than the radio range of a single unit.

The sound beacon 106 may also include one or more speakers 108. The sound beacon may utilize WiFi, and/or Bluetooth for music transmission between individual sound beacons, from the hub 104, and/or other devices. The sound beacon 106 may also utilize Bluetooth as part of the music listening experience. It will be appreciated that the sound beacon may also use WiFi standard enabling devices to easily connect with each other without requiring a wireless access point. It may be used for anything from Internet browsing to file transfer, and to communicate with more than one device simultaneously at typical WiFi speeds. The sound beacon may include Wi-Fi Direct and may include the ability to connect devices even if they are from different manufacturers. Only one of the Wi-Fi devices needs to be compliant with Wi-Fi Direct to establish a peer-to-peer connection that transfers data directly between them with greatly reduced setup.

Wi-Fi Direct negotiates the link with a WiFi Protected Setup system that assigns each device a limited wireless access point. The pairing of Wi-Fi Direct devices can be set up to require the proximity of a near field communication, a Bluetooth signal, or a button press on one or all the devices. Wi-Fi Direct may not only replace the need for routers, but may also replace the need of Bluetooth for applications that do not rely on low energy.

It will be appreciated that Wi-Fi Direct essentially embeds a software access point into any device. The software access point provides a version of WiFi Protected Setup with its push-button or PIN-based setup. When a device enters the range of the Wi-Fi Direct host, it can connect to it, and then gather setup information using a Protected Setup-style transfer.

Software access points can be as simple or as complex as the role requires. A digital picture frame might provide only the most basic services needed to allow digital cameras to connect and upload images. A smart phone that allows data tethering might run a more complex software access point that adds the ability to bridge to the Internet. The standard also includes WPA2 security and features to control access within corporate networks. Wi-Fi Direct-certified devices can connect one-to-one or one-to-many and not all connected products need to be Wi-Fi Direct-certified. One Wi-Fi Direct enabled device can connect to legacy WiFi certified devices.

The sound beacon 106 may also include detection and location technology that may be utilized to detect motion and identify or locate where the motion is coming from over an entire floor plan. For example, as a user enters a room, the detection and location technology detects the motion from the user and identifies where the motion is coming from. The system may then utilize that information for various security or other purposes, including turning on and off audio, visual, lighting, heating or other automated devices.

For example, one such detect and locate technology that detects motion over complete floor plans, even through walls, is manufactured by Xandem. The Xandem technology may remain completely hidden from view, but operates to locate motion over large areas, and is configurable as smart zones, may be integrated via LAN and Xandem cloud services. Information regarding Xandem's motion and location detection is available in U.S. Pat. No. 8,710,984.

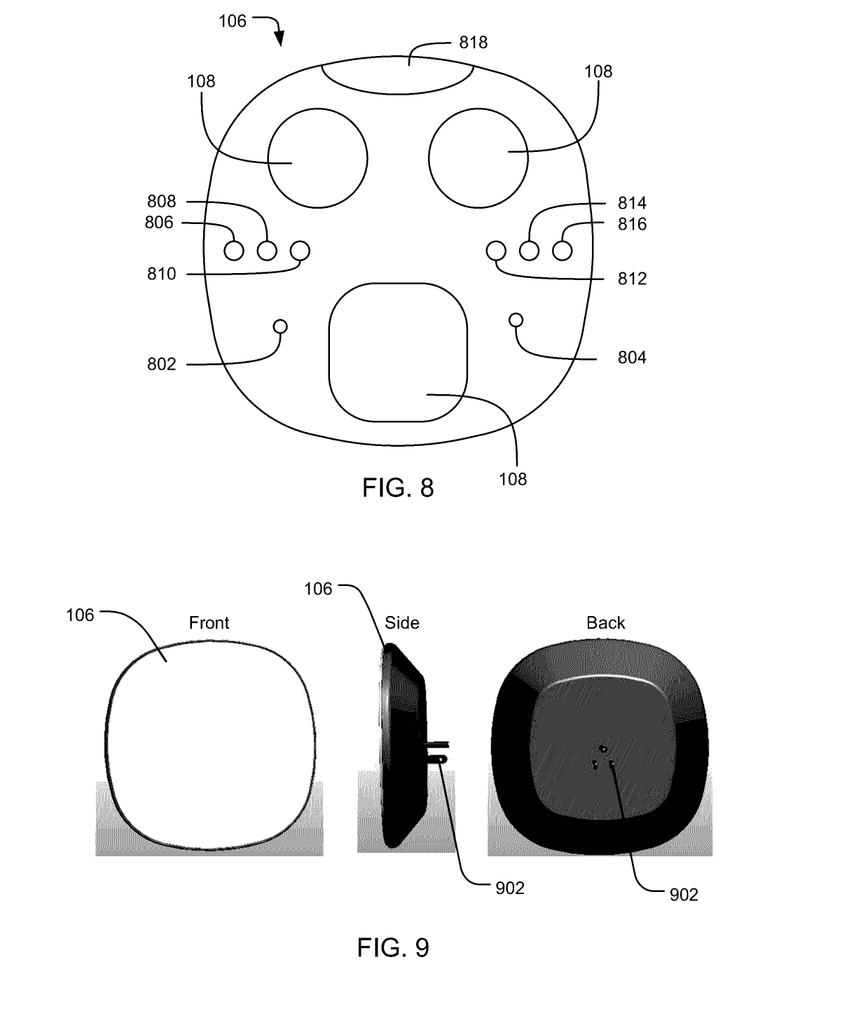

FIG. 8 is a schematic front view of a sound beacon 106 with a cover removed, according to one embodiment. The sound beacon 106 includes a plurality of speakers 108 for playing audible alerts, sounds, messages, phone calls, or the like. The sound beacon also includes a left microphone 802 and a right microphone 804 for capturing voice, sounds, or other audio for calls, commands, alarm sound detection, or the like. The sound beacon 106 also includes a plurality of buttons including a WiFi pairing button 806, a reset button 808 (to reset operation), a Z-Wave pairing button 810 (for pairing with Z-Wave devices or systems), a volume up button 812, a multi-use button 814, and a volume down button 816. One or more of the buttons 806-816 may be backlight so that they can be viewed through a cover (such as a mesh or grid cover). The multi-use button 814 may be used for powering a vehicle on or off, providing notifications to a user, or providing other input. A cavity 818 may contain one or more environmental sensors such as temperature, air quality, light, and humidity sensors.

FIG. 9 includes a front, side, and back view illustrating an external shape of a sound beacon 106, according to one embodiment. The sound beacon 106 includes prongs 902 for connecting directly into a wall plug or onto an extension cord. For example, the sound beacon 106 may be mounted directly into an outlet on a wall so that the sound beacon 106 is mounted on the wall and held up by the prongs 902 and outlet.

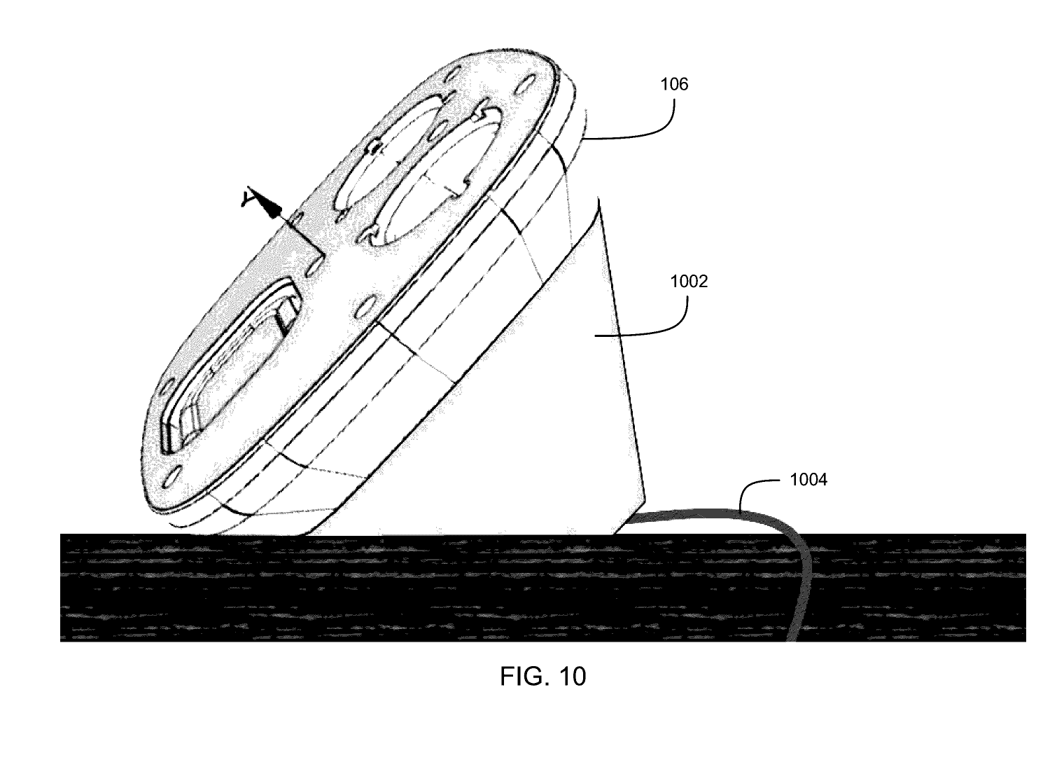

FIG. 10 illustrates a perspective view of a sound beacon 106 docked in a docking station 1002. The docking station 1002 includes a table stand that rests on a horizontal surface and allows the sound beacon 106 to be selectively docked. The sound beacon 106 may include prongs similar to shown in FIG. 9 which may be selectively plugged into either a wall outlet or the docking station 1002. The docking station 1002 includes a power cord 1004 which may be plugged into a wall outlet. In one embodiment, the docking station 1002 may convert voltages or provide a cord 1004 that is able to adapt to different types of plugs or power outlets with different power supply standards. For example, the docking station 1002 may be used to allow a sound beacon 106 that is configured to connect to power outlets according to a first standard (e.g., in a first country) to be used with power outlet using a second standard (e.g., in a second, different country). In one embodiment, a sound beacon 106 may include a cord to connect to a power outlet so that it can be positioned on a desk or horizontal surface without the need for a docking station.

Embodiments of sound beacons 106 disclosed herein provide convenience in providing features for entertainment, security, communication, and the like without expensive or difficult installation processes. For example, a sound beacon 106 may simply be plugged into an available outlet in a location where sound, security, or other features of the sound beacon are desired. Because the sound beacons 106 are wireless, no wiring or damage to walls is required. With simple pairing features, the sound beacons 106 can provide a wide array of features and functionality with very little set-up or configuration, bringing powerful home automation, whole home audio, emergency response, alarm system, or other features to a home or living space.

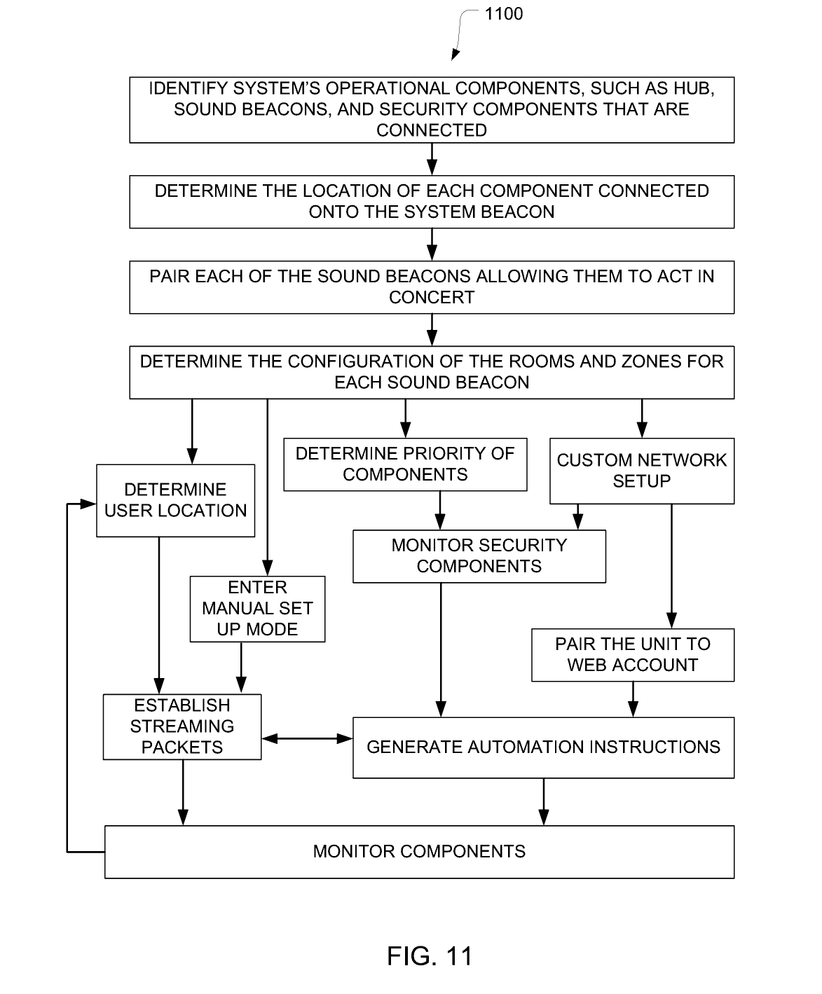

Referring now to FIG. 11, a method 1100 for providing home security, entertainment, and communication in accordance with the teachings and principles of the disclosure is illustrated. For example, the method 1100 may be performed by a hub or centralized controller, such as the hub 104 of FIG. 1. In one embodiment, a sound beacon 106 operating as a master may perform the method 1100.

The method 100 includes identifying the system's operational components, such as hub, sound beacons, and security components that are connected. For example, a hub 104 may perform wireless or wired discovery to identify a number of sound beacons 106, discover a wired or wireless network, detect any smart phones or mobile communication devices, or identify any security systems. The method 1100 may further include determining the location of each component connected onto the system beacon. For example, the hub 104 may identify a location (e.g., a zone) for each of the sound beacons 106 so that the hub 104 may know which beacons correspond to which areas or zones of a building. The method 104 may further include pairing each of the sound beacons allowing them to act in concert. For example, the sound beacons 106 may pair with one or more other sound beacons so that they can act as repeaters of information or coordinate sound or communication handoff. The method 1100 may further include determining the configuration of the rooms and zones for each sound beacon. The method 1100 may then determine the user's location within a structure, office building or dwelling. The method 1100 may further include establishing streaming packets, generating automation instructions and then monitoring the components. The method 1100 may then continue through a loop by determining an updated or new user location and repeating the method.

In another aspect, the method 1100 may include identifying the system's operational components, such as hub, one or more sound beacons, and any security components that are connected. The method 1100 may further include determining the location of each component connected onto the system beacon. For example, the method 1100 may include determining a zone to which a sound beacon 106 belongs. The method 1100 may further include pairing each of the sound beacons allowing them to act in concert or to have coordination operation. The method 1100 may further include determining the configuration of the rooms and zones for each sound beacon. The method 1100 may include determining the priority of the components and then monitoring security components. The method 1100 may further include establishing streaming packets, generating automation instructions and then monitoring the components. The method 1100 may continue through a monitoring loop back to monitoring security components and repeating the method.

In another aspect, the method 1100 may include identifying the system's operational components, such as hub, sound beacons, and security components that are connected. The method 1100 may further include determining the location of each component connected onto the system beacon. The method 1100 may further include pairing each of the sound beacons allowing them to act in concert. The method 1100 may further include determining the configuration of the rooms and zones for each sound beacon. The method 1100 may further include customizing the network setup and pairing the device or unit to a web account. The method 1100 may further include establishing streaming packets, generating automation instructions and then monitoring the components.

In another aspect of the method, the method 1100 may include identifying the system's operational components, such as hub, sound beacons, and security components that are connected. The method 1100 may further include determining the location of each component connected onto the system beacon. The method 1100 may further include pairing each of the sound beacons allowing them to act in concert. The method 1100 may further include determining the configuration of the rooms and zones for each sound beacon. The method 1100 may further include entering into a manual set up or user mode. The method 1100 may further include establishing streaming packets, generating automation instructions and then monitoring the components.

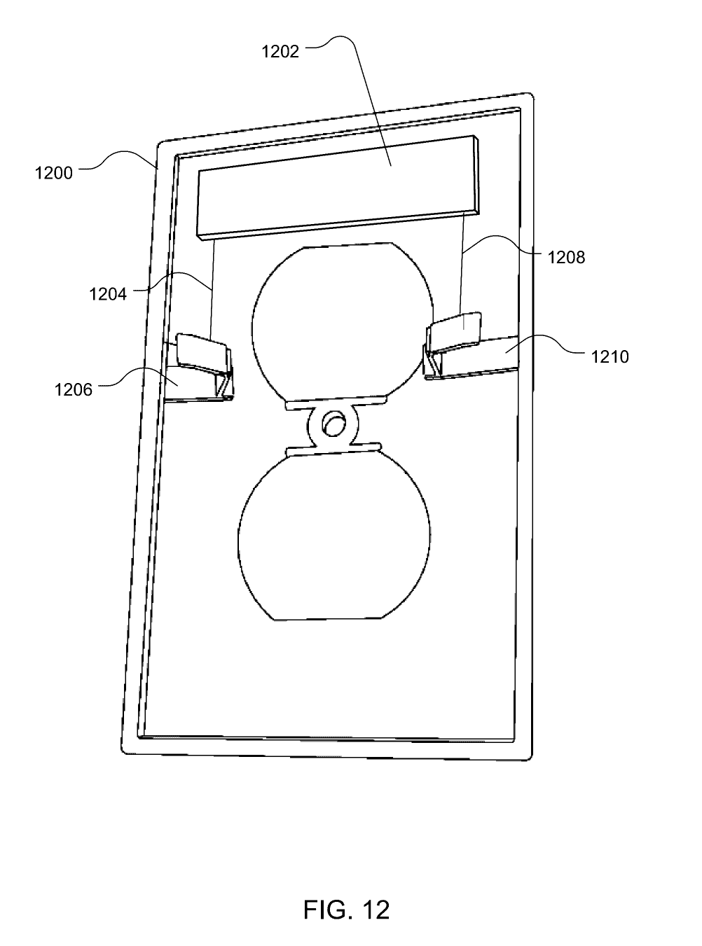

In one embodiment, a sound beacon 106 may include a faceplate with built in circuitry, radios, speaker, or the like. For example, the faceplate may include any components or be configured to perform any of the functions or procedures discussed in relation to the sound beacon 106. FIG. 12 is a perspective view of one embodiment of a faceplate 1200. In one embodiment, the faceplate 1200 may include contacts to connect to an electrical receptacle. For example, the faceplate 1200 may be a faceplate similar to that described in U.S. Pat. No. 8,912,442 assigned to SnapPower® except that the faceplate 1200 has a different load and functionality provided by that load. In one embodiment, the faceplate 1200 may include any of the functionality of the hub 104 or sound beacon 106 discussed herein. For example, the faceplate 1200 includes a circuit 1202 which may implement one or more of the modules, components, sensors, or devices of the hub 104 or sound beacon 106. The circuit 1202 may derive power from the conductors 1204, 1208 which are connected to contacts 1206, 12100 which may contact screw heads or other electrical conductors of an electrical receptacle.

In one embodiment, incorporation of the functionality of the hub 104 or sound beacon 106 in a faceplate 1200 may allow for easy and hidden retrofitting of existing structures and buildings to include the systems, hub(s), and/or sound beacon(s) discussed herein. The circuit 1202 may include control circuitry, a processor, computer readable memory, radios, antennas, speakers, microphones, or the like to enable the faceplate 1200 to provide audio, wireless communication, location detection, or any other functionality discussed herein. For example, the circuit 1202 may include a sound driving circuit that controls one or more speakers built into the faceplate 1200. For example, the sound driving circuit and the one or more speakers may be similar to audio systems on mobile computing devices such as mobile phones, tablets, laptops, etc. Similarly, the circuit 1202 may include one or more radios such as Bluetooth radios, Z-Wave radios, DECT radio, WiFi radio, Libre radio, Xandem radio, or the like.

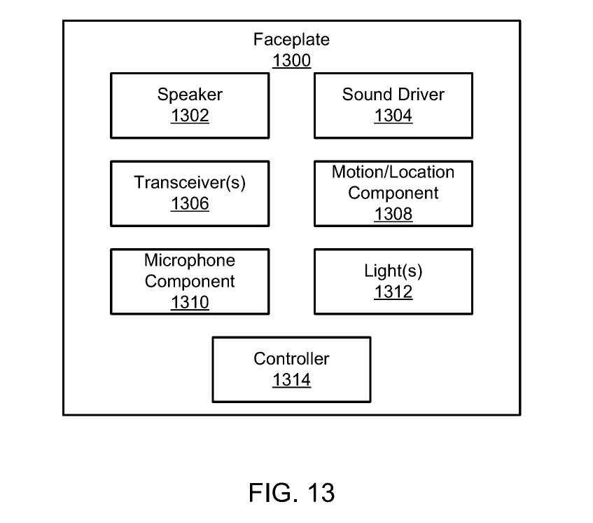

Turning to FIG. 13, a block diagram illustrates example components of a faceplate 1204, such as the faceplate 1200 of FIG. 12. The faceplate 1204 includes one or more of a speaker 1302, a sound driver 1304, transceiver(s) 1306, a motion/location component 1308, a microphone component 1310, light(s) 1312, and a controller 1314. Various embodiments may include any one or any combination of two or more of the components 1302-1314.

The speaker 1302 and sound driver 1304 may include one or more speakers for playing audio messages, music, or other sounds. For example, the speaker 1302 may include one or more speakers facing outward from the faceplate to project audio into a room or zone. In one embodiment, the faceplate 1204 may include audio or sound drivers 1304 similar to audio drivers on mobile phones. In one embodiment, the sound driver 1304 may include an audio jack or wireless radio to connect to and play audio on an external speaker or device.

The transceiver(s) 1306 may include one or more wired or wireless transceivers for wired or wireless communication. For example, the transceiver(s) 1306 may include one or more radios that communicate over frequencies and implement communication standards or communications discussed herein. For example, the transceiver(s) 1306 may include one or more of a Bluetooth, Z-Wave, Xandem, Libre, DECT, WiFi, or other radio. The transceiver(s) 1306 may be used to relay, send, and/or receive information such as music, positioning or motion information, Internet packets, voice communications such as VoIP, alarm or alert messages, or any other type of data discussed herein.

The motion/location component 1308 is configured to detect motion and/or a location of motion. In one embodiment, the motion/location component 1308 may include a radio and/or processing circuitry to detect motion and/or a location of motion using TMB. In one embodiment, the motion/location component 1308 includes a node of a wireless detection network, such as that disclosed by Xandem in U.S. Pat. No. 8,710,984. In one embodiment, the motion/location component 1308 is configured to periodically detect changes in radio signals sent by other nodes and report these changes to a central node or controller, such as a hub 104. In one embodiment, the motion/location component 1308 is configured to periodically transmit a signal for reception by other nodes to allow those nodes to detect changes or interference in the signal. For example, changes in the signals may indicate a movement or disturbance between different nodes.

The microphone component 1310 may include a microphone to capture audio to enable room-to-room communication, room-to-phone communication, voice controls, and/or location detection. In one embodiment, audio captured by the microphone component 1310 may be transmitted to one or more other faceplates, hubs, or sound beacons for recording, forwarding, or processing. For example, the capture audio may be processed to detect voice instructions to trigger procedures or action to be taken by a hub, sound beacon, security system, or other system or device. In one embodiment, captured audio may be processed and/or detected locally to a sound beacon 106 and/or faceplate 1300. For example, the controller 1314, or other microcontroller, processors, or processing unit, may detect a specific word or phrase and trigger an action (initiate siren, initiate two-way call, play music, send a query to a web service).

The light(s) 1312 may include one or more light emitting diodes (LEDs) or other lamps to emit light. In one embodiment, the light(s) 1312 may be used for illumination of a room or zone (mood lighting, night light, alarm strobe, etc.), alarm notification, alert notification, or other operations of the faceplate 1204 or of a corresponding sound beacon, hub, or other device.

The controller 1314 is configured to initiate processes, procedures, or communications to be performed by the faceplate 1204. For example, the controller may activate the playing of audio at the speaker 1302 using the sound driver 1304 in response to the transceiver(s) 1306 receiving a message that indicates audio information should be played. In one embodiment, the controller 1314 may control what audio is played and when and/or what information is transmitted or received using the transceivers. For example, the controller 1314 may cause the playing of streaming music to cease momentarily to allow an alert (such as an alert for a phone or voice call, security alert, or other alert) to be played on the speaker 1302, after which the music may resume. Similarly, the controller 1314 may coordinate with the motion/location component 1308 and transceiver(s) 1303 to ensure that motion detection is periodically performed while allowing for the reception/processing of received messages or transmission of data. In one embodiment, the controller 1314 may include one or more of a processor and computer readable medium in communication with the processor storing instructions executable by the processor. For example, the instructions may cause the processor to control the faceplate 1204 to perform any of the procedures discussed herein.

The faceplates 1200 and 1204 may include circuitry, instructions on computer readable media, or any other means or components to perform any of the functions or procedures discussed in relation to one or more of the hub 104, the sound beacons 106, or other systems discussed herein. In one embodiment, any of the features, components, or the like discussed in relation to the faceplate 1300 may be included in any of the sound beacon 106 embodiments disclosed herein.

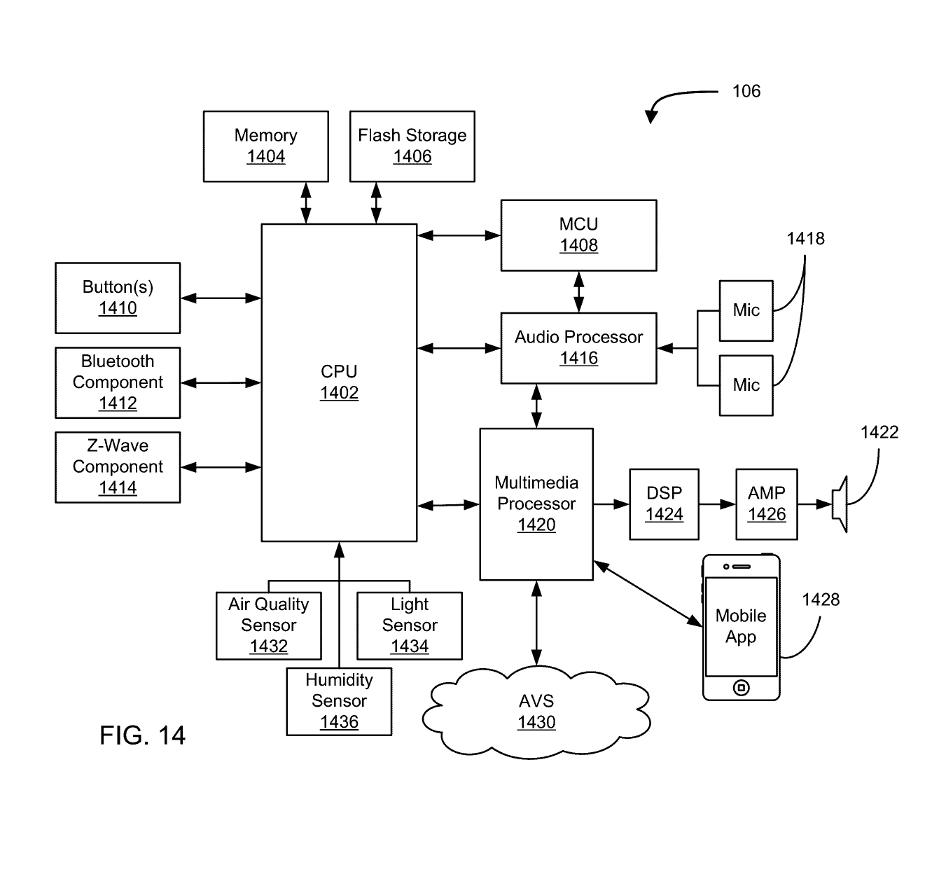

FIG. 14 is a schematic block diagram illustrating one embodiment of components and interconnections of a sound beacon 106. The sound beacon 106 includes a central processing unit (CPU) 1402 for processing and controlling operation of the sound beacon 106. In one embodiment, the CPU 1402 includes an MT7628 chip available from MediaTek®. The CPU 1402 may receive and communicate media data, sensor data, and other data between the sound beacon 106 and other devices, such as a smart phone, remote cloud storage or services, or the like. Memory 1404 may be used as random access memory (RAM). In one embodiment, memory 1404 includes DDR2 memory. Flash storage 1406 may be used for non-volatile or long term memory storage. For example, the flash storage 1406 may include serial peripheral interface (SPI) flash member which may be used for storing computer readable instructions to control operation of the sound beacon 106 according to embodiments and principles disclosed herein. For example, program instructions may be loaded from the flash storage 1406 into memory 1404 during boot up for controlling operation of the sound beacon 106. The sound beacon 106 may also include a microcontroller unit (MCU) 1408 for processing or implementing instructions stored in the flash storage 1406 and/or controlling operation of the CPU 1402. In one embodiment, the MCU may include an STM32 processing unit available from STMicroelectronics®.

The sound beacon 106 includes a plurality of buttons 1410 for controlling pairing, a power state, volume, or other operations of the sound beacon 106. A Bluetooth component 1412 may include an antenna and circuitry for communicating according to a Bluetooth standard. The Bluetooth component 1412 may enable short range communication, Bluetooth location services (such as using iBeacon®, Eddystone®), or other Bluetooth communication/services. In one embodiment, the Bluetooth component 1412 includes a QN9021 chip available from NXP Semiconductors. A Z-Wave component 1414 may include an antenna and circuitry to communicate using a Z-Wave communication standard. For example, the Z-Wave component 1414 may be used for communicating with a hub, alarm controller or panel, or other Z-Wave device or controller.

An audio processor 1416 may be used for processing voice commands or voice data received through microphones 1418. The audio processor 1416 may include a ZL83062 chip available from Microsemi®. The audio processor 1416 may detect trigger words, or specific types of sounds to trigger operations by the sound beacon 106. For example, a first trigger word may be used to initiate a query or voice command to a remote speech-to-text service (e.g., such as services available through Amazon®, Apple®, Google®, or the like) while a second trigger word may be used to initiate a two-way voice call or room to room communication. Trigger sounds, such as fire alarms sounds or breaking glass, may trigger an alarm signal to a hub or alarm system controller, a siren, and/or flashing of lights. A multimedia processor 1420 may be included for processing and/or streaming of audio data from a remote source or smart device to a speaker 1422 via a digital signal processor (DSP) 1424 and an amplifier (AMP) 1426. The multimedia processor 1420 may include a built-in WiFi radio and/or antenna for communicating with a WiFi router or node. For example commands may be received from a mobile app executed on a mobile device 1428, the audio processor 1416, and/or the CPU 1402 to trigger audio playback from a mobile devices 1428 or cloud services implementing an audio video standard (AVS) 1430. For example, voice responses from a cloud service may be received and played back on one or more speakers 1422. The voice responses may include text-to-speech information provided in response to a voice query received by the audio processor 1416. As another example, streaming music may be received from a cloud services or mobile device 1428. Similarly, a two-way call between the sound beacon 106 and a remote emergency response service, or other phone or call location may be instigated. The multimedia processor 1420 may include an LS6 WiFi Media Module available through Libre Wireless Technologies, Inc.

A plurality of sensors including an air quality sensor 1432, light sensor 1434, humidity sensor 1436, or any other sensor may be included. The sensor data may be gathered and uploaded to a cloud location for storage and/or viewing by a user. In one embodiment, sensor data outside a preconfigured or user-specified range may be used to trigger an action, such as triggering a heating or cooling system, sending a notification to a user, increasing a brightness of a light (such as LED emitters integrated with the sound beacon 106), or the like.

### Voice or Audio Commands/Triggers

The sound beacon 106 may respond to a plurality of different sounds or commands. In one embodiment, the flash storage 1406 or other component of the sound beacon 106 stores a table mapping commands or sounds to operations to be performed by the sound beacon 106. In one embodiment, a plurality of wake words may be used to trigger an operation. For example, a wake word may include a word configured to indicate that a voice command will follow. The audio processor 1416 may be configured to detect one or more wake words (user defined or predefined wake words) and send an indication of what wake word (or sound) was detected to the CPU 1402 or MCU 1408. The CPU 1402 or MCU 1408 may then trigger the sound beacon 106 to listen and process voice controls. For example, the wake word may include a wake word for any known voice services such as “Siri” for Apple®, “Alexa” for Microsoft®, “OK Google” for Google®, or any other wake word. Following detection of the wake word, the audio processor 1416 may record, listen, and or perform speech-to-text on subsequent words. These subsequent words may be processed locally by the sound beacon or may be forwarded to a cloud speech interpretation service in order to determine how to respond to the command. One example of a wake word, or wake series of words, is “Help help help” to indicate an emergency. In response to a detected “Help help help” voice command, the sound beacon may initiate a two-way call with an emergency call services, such as a service provided by an alarm company, government organization (e.g., 911 calls), or the like. In one embodiment, the “help help help” keyword may be used as a personal emergency response (PERS) keyword to connect a user immediately with emergency personnel. A user may be able to set any other sound or word as the PERS keyword.

In one embodiment, the audio processor 1416 may detect specific types of non-word sounds. For example, the audio processor 1416 may have a plurality of pre-determined sounds, or user defined or recorded sounds. Example sounds include the sound of a smoke alarm, fire alarm, door bell, breaking glass, or the like. Smoke alarms and breaking glass have distinct audio signatures which may be detected by the audio processor 1416. For example, the sound beacon 106 may accurately detect glass breaking from up to 30 feet away. The audio processor 1416 may also detect audio of a baby crying and cause a voice notification on a different sound beacon 106 to notify a parent or caretaker. The sound beacon 106 and/or audio processor 1416 may also include a learn function where a user, using a mobile app on a mobile device 1428 indicates to the sound beacon 106 to learn a sound. A user may then cause the sound to be played (e.g., plays a doorbell, plays a siren, causes a phone to ring, or triggers any other sound) and the audio processors 1416 of one or more sound beacons 106 at installed locations may detect and learn that sound. The user may also indicate an action to be taken when the learned sound is detected, such as notify the user using an email, phone call, or text message. An identifier for the sound and the corresponding action may be stored in a table within the flash storage 1406.

Upon detection, the audio processor 1416 may send a signal to the CPU 1402 or MCU 1408 with an identifier indicating what type of sound was detected. The CPU 1402 and/or the MCU 1408 may look up the identifier in a table stored in the flash storage 1406 to determine an action or response to be performed. Example responses to detection of a smoke alarm sound or breaking glass may include playing a siren sound on the speaker 1422 of the sound beacon 106, flashing built in lights (strobe lights), sending a Z-wave signal to a hub or controller indicating an alarm status, and/or initiating a two-way call between the sound beacon 106 to an emergency number or service.

### PRIORITY

Due to the large number of functions which may be performed or provided by the sound beacon, prioritization of actions may be required. For example, each type of action may have an interrupt request number and each interrupt request number may have a corresponding priority. A higher priority item may stop or interrupt a lower priority item but may not stop or interrupt an item of the same or higher priority. Following is a list of actions ordered according to priority: emergency calls, alarms, phone calls, intercom communication, user voice commands, sensor data capture and storage, and audio/music playback. This list is given by way of example only and may be modified to change an order, add items, or remove items without limitation.

### Alarm Response

The sound beacon 106 may provide fast, robust, and intelligent response to alarm triggers or emergency situations, with or without the presence of or connection to a hub or alarm controller. In one embodiment, the sound beacon 106 may respond to an alarm condition by playing a siren sound. The siren sound may include a loud siren that will wake residents, deter criminals, and/or notify nearby people external to a structure. In one embodiment, the sound beacon 106 may strobe lights. For example, the sound beacon 106 may flash one or more built-in lights to indicate an alarm status or emergency situation. For example, the MCU 1408 may cause an LED board to start flashing. In one embodiment all sound beacons 106 may flash and/or play a siren sound when an emergency situation is detected. For example, each sound beacon 106 may broadcast of forward a signal that indicates that an emergency situation has occurred so that all sound beacons 106 at a location will be triggered.

In one embodiment, the sound beacon 106 may notify other devices of the alarm or emergency. For example, the sound beacon 106 may send a WiFi message to a router for forwarding to a cloud location, send a Z-wave message to a hub or alarm controller, or notify another sound beacon 106 of the alarm/emergency. In one embodiment, the sound beacon 106 may send a request to a mobile device, hub, or cloud location triggering an emergency call to an emergency number or service. For example, a two-way voice call using the microphones 1418 and/or speaker 1422 may be initiated to allow emergency response personnel (e.g., police, medical, fire, or alarm company personnel) to speak with a resident or hear what is happening at the location of the emergency. For example, in response to an emergency, a the sound beacon 106 may immediately trigger a siren, flashing of lights, alarm forwarding to other devices or systems, and initiating a two way call. The siren and flashing lights may continue until both parties of the two-way call are connected and a voice session is initiated. At that point, the sound beacon(s) 106 participating in the two-way call may cease the siren and/or flashing lights during the duration of the two-way call to allow voice communication.

The sound beacon 106 may also determine whether an alarm or emergency state currently exists. In one embodiment, the sound beacon 106 may determine that an emergency or alarm state exists in response to receiving an alarm signal via Z-Wave from a hub or other controller. In one embodiment, the sound beacon 106 may determine that an emergency or alarm state exists in response to receiving a WiFi signal from a peer sound beacon 106 indicating an alarm or emergency status. In one embodiment, the sound beacon 106 may determine that an emergency or alarm state exists in response to detecting a sound, such as an alarm sound, smoke alarm, breaking glass, or the like. In one embodiment, the sound beacon 106 may determine that an emergency or alarm state exists in response to detecting a voice command such as a “Help help help” command. In one embodiment, an audio processor 1416 detects a sound or command, notifies an MCU 1408 or CPU 1402, the MCU 1408 or CPU 1402 checks a look-up table in flash storage 1406 or memory 1404 to determine what actions to take, and the MCU 1408 or CPU 1402 initiate the action.

### Intercom

In one embodiment, the sound beacon 106 may participate in intercom communication with another device. For example, the sound beacon 106 may receive audio from a mobile device 1428 and play that audio on a speaker 1422. The mobile device 1428 may include a mobile app where a user can use a push to talk feature to push sound captured by the mobile devices via a WiFi node (or WiFi-Direct) to the sound beacon 106. Packets that include audio data may include a header or identification indicating that the payload data includes intercom communication. When a user of the mobile device 1428 releases a push button, audio at location of the smart beacon 106 may be streamed back to the mobile device 1428 for playback. The mobile app on the mobile devices 1428 may include an IP address for a specific sound beacon 106 and/or an identifier for a specific zone within a house. Based on the IP address or zone, corresponding sound beacons 106 may participate in the intercom communication. Thus, a user may have a two-way intercom communication session using the sound beacon 106 and a mobile device 1428. With push to talk, the intercom session may operate similar to a hand radio or walky-talky style communication at the mobile device 1428 in which sound communicated in only one direction during a given time period. For example, sound from the mobile devices 1428 may be pushed to the sound beacon 106 during one time period and sound may be received from a sound beacon 106 during a second time period.

In one embodiment, communication between the mobile device 1428 and the sound beacon 106 may trigger a voice call using a voice over IP protocol and/or a session initiate protocol (SIP). For example, the mobile devices 1428 may initiate a call via a remote server that connects with the sound beacon 106 to provide a two-way call. The two-way call may allow simultaneous two-way voice communication between the mobile device 1428 and the sound beacon 106. The two-way voice intercom call may be initiated with an identifier for a zone or specific sound beacon 106 that should be an end-point for the call. During the call, the mobile devices 1428 and sound beacon 106 may operate similar to a speaker phone call in which both parties can speak and hear the other party at the same time.

A computing device, such as the mobile computing device 1428 may perform a method that includes connecting to one or more sound beacons via WiFi. The computing device obtains an IP address or zone information for one or more sound beacon. The computing device receives input on an interface from a user initiating an intercom session with the sound beacon. The indication may indicate a specific person or a specific zone in a home where the intercom session should take place. The location of user with respect to the zones may be determined and the corresponding zone(s) may be selected for intercom communication. During a period when an indicator is selected on the computing device, the mobile device sends audio from mobile device to one or more sound beacons that correspond to a selected person or zone for playback. The indicator may include a “sticky” indicator, in which a single touch causes the indicator to remain selected until a user touches the indicator again to deselect the indicator. During a period when the indicator is not selected, a sound beacon obtains sound at its location and sends the audio to the computing device, which plays the sound. The sound beacon and/or computing device may receive an indication that the intercom session is finished and will stop communicating audio between the mobile device and the sound beacon.

### Two-Way Voice Call

The sound beacon 106 may participate as an end-point in a two-way call. The sound beacon 106 may operate as an end point for a voice call using VOIP, SIP, or other communication standard. In one embodiment, the sound beacon 106 may initiate a two-way voice call directly or send a request to another device or server to initiate the two-way voice call. The two-way voice call may be initiated in response to an emergency, voice command, remote request, or the like. In one embodiment, a two-way voice call may be initiated in response to a Z-Wave message received from a hub, controller, or Z-Wave device.

The two-wave voice call may be initiated by the sound beacon 106 sending a message to a cloud service requesting a voice call with a specific party or entity. For example, the sound beacon 106 may send a message indicating a request for a voice call and requesting an emergency service. A receiving entity may then trigger a voice call to the emergency service and also establish a connection with the sound beacon 106. When the emergency service responds, the receiving entity may connect the emergency entity with the sound beacon 106 to establish and allow voice communication.

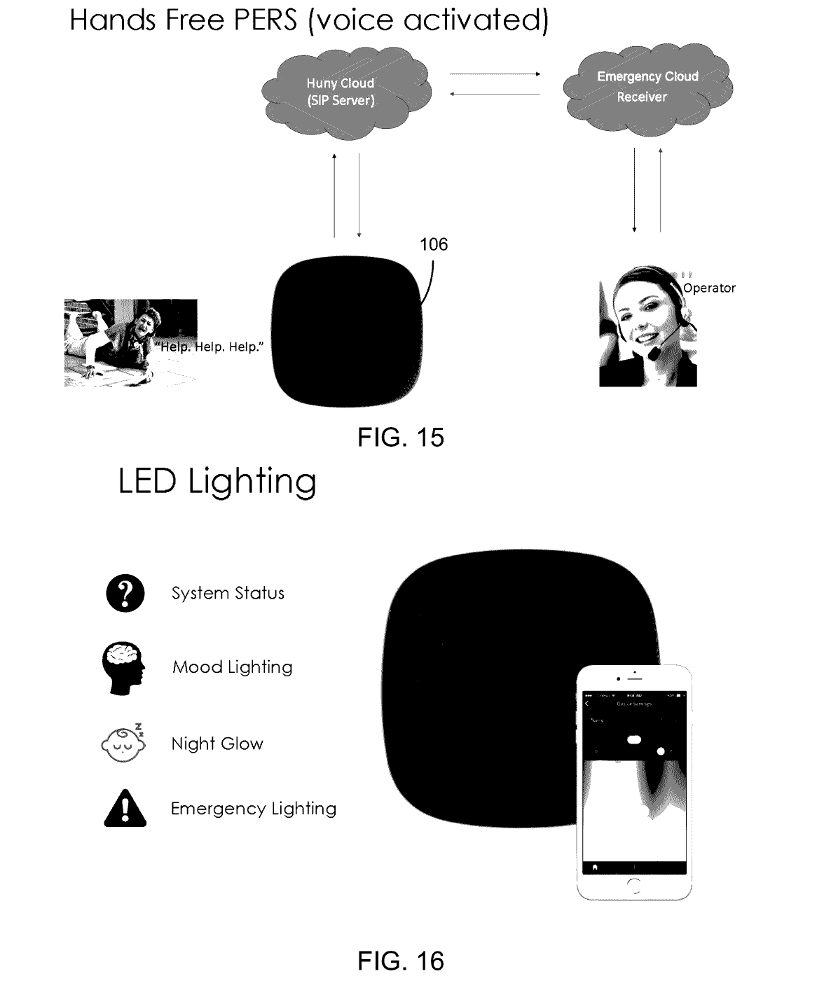

A sound beacon 106 may perform a method that includes pairing with another Z-Wave device, such as a hub or controller. Example controllers include home automation controllers, alarm system controllers, audio system controllers, or the like. The method includes the sound beacon 106 detecting an alarm or emergency condition. For example, the sound beacon 106 may detect a break-in, a fire, a voice command indicating an emergency, or any other event discussed herein. The alarm or emergency status may be determined locally or based on a Z-Wave, WiFi, or other message received from another source, such as another sound beacon 106 or an alarm controller. In response to the event, the method includes the MCU 1408 or CPU 1402 of the sound beacon 106 initiates a two-way call. For example, the sound beacon may initiate the call by sending a Z-Wave message to a controller or hub. The controller or hub may then initiate a call between the sound beacon 106 and a remote party. In one embodiment, the sound beacon 106 may send a message directly to a cloud service via a WiFi router to trigger a call with the cloud service or to cause the cloud service to initiate the call back to the sound beacon 106. If a siren is currently playing on the sound beacon 106, the siren may be muted during duration the call. FIG. 15 illustrates a voice call between a sound beacon 106 and an operator. The voice communication session is shown occurring via an SIP server and a cloud receiver for an emergency response center. Triggering of the call may be in response to a “Help help help” command received from a user. For example, the user may be have fallen alone and not be able to get back up, reach a phone or other communication device. However, the user may have sufficient strength to speak a voice command and thereby initiate a call for help. Voice activated two-way calls allows a sound beacon 106 to operate as a personal emergency response system (PERS) which may be useful for senior or disabled individuals who live alone or spend significant time alone without a caretaker.

### Sensor Data

In one embodiment, the sound beacon 106 may obtain environmental data from a location of the sound beacon 106. The environmental data may include data from sensors integrated into the sound beacon 106. Example sensor data includes temperature information, humidity information, a light level, air quality information, or the like. In one embodiment, the CPU 1402 receives sensor data from one or more sensors and initiates an upload to a cloud location for storage. For example, the CPU 1402 may obtain sensor data on a periodic basis (every 15 seconds, every minute, every thirty minutes, every hour, or other time period) and store the sensor data at a cloud location. A user may then access the cloud location to review the historical data. In one embodiment, the CPU 1402 may compare a sensor value to an acceptable range, with a min and/or max value. If the value falls outside of the range, an action may be triggered. Example actions include sending of an alert to a user (phone, email, etc.) triggering a heating or cooling system, or the like. The actions may include alerts or communications to other systems through one or more exit paths. For example, an alert or communication indicating that a sensed value is outside a range may be sent through a WiFi path to a cloud and also through a Z-Wave path to a controller or hub. The cloud and/or the hub may respond to the communication based on a predetermined action. For example, a hub or home automation controller may trigger the closing of a heating or cooling vent or of providing an internal warning or alert via a sound beacon 106.

### Whole Home Audio

Using one or more sound beacons 106 audio may be provided over a large area of a home, or even throughout a whole home. In one embodiment, sound beacons 106 may pair with each other via Bluetooth or WiFi to coordinate audio playback. In one embodiment, sound beacons 106 are grouped into one or more zones with one sound beacon 106 operating as master to coordinate playback and/or operation within the zone. Playback at each sound beacon may be controlled by a multimedia processor 1420. In one embodiment, the each sound beacon 106 is connected via WiFi to a home network. Streaming audio is then received from a mobile devices 1428 or cloud service and played on corresponding speakers 1422. A master sound beacon 106 may receive the audio stream and then forward data to other sound beacons 106 within the same zone. In one embodiment, zones may overlap. For example, a single sound beacon 106 may be a member of multiple different zones. As a user moves from room to room, a location of the user may be determined and audio may be played only in a zone where the user is located or on sound beacons closed to a user.

### Location Detection

The sound beacon 106 may be used to determine a location of one or more individuals within a room or home. Location detection may be performed using Bluetooth beacons, or any other movement detection, device detection, or heat detection system. In one embodiment, the sound beacon 106 performs detection of Bluetooth devices or Bluetooth beacons using a Bluetooth component 1412. In one embodiment, the Bluetooth component 1412 may detect a user's mobile devices, Bluetooth beacons available from low energy transceivers using iBeacon®, Eddystone® or other technologies or standards. For example, the sound beacon 106 may detect and/or determine a proximity or movement of a user based on a mobile device 1428 or low energy transceiver that is moving with the user.

In one embodiment, a mobile device 1428 or sound beacon may trigger an action based on the user's location. For example, music may “follow” a user through the house and music may only be played to locations where people/users are present. Similarly lights may be dimmed or powered on based on the user's location.

In one embodiment, a mobile app on a mobile device 1428 may determine its proximity to one or more sound beacons 106 or other devices. For example, the mobile device 1428 may determine that it is within a specific zone based on detecting a sound beacon 106 within that zone. In one embodiment, the user may be able to pull up a mobile app that interacts with the sound beacons 106, an automation system, an entertainment system, and/or an alarm system. Based on the current location, the user is presented with options based on the location. Thus, the user may be shown options for devices or systems in a current room, rather than those in a different region of a house or residence. Thus, when a user walks into a room, a mobile app determines what options to present in a widget or interface for the user to control or provide input. Thus, a user may not need to dig through a large amount of functions or devices in order to select the option the user wants to modify or select.

In one embodiment, a computing device, such as a mobile device 1428, may perform a method that includes determining a current zone or location of the computing device. The computing device may determine its location based on Bluetooth beacon technology, based on communication from a network, or the like. In one embodiment, a computing device may receive an ID from a sound beacon so that the computing device can determine its location or zone. In one embodiment, the sound beacon 106 may detect the computing device and send a Z-Wave message to a controller or hub to turn on lights, turn off an alarm, trigger an alarm, or the like. In one embodiment, the sound beacon 106 or mobile app may send a message to a cloud service to trigger control of one or more devices. For example, the sound beacon t106 may send a message through a cloud to a web service to tell a bulb or heating and cooling system to activate.

In one embodiment, a sound beacon 106 may detect an alarm condition based on detecting a Bluetooth device when an alarm is activated. For example, a resident may leave a residence and indicate to an alarm system and/or sound beacon that the user is leaving via a mobile device 1428. The sound beacon 106 may determine that a resident or owner is absent, or should be absent, based on an indication from the user's device, a Z-Wave communication from an alarm system, or from another message. In one embodiment, the sound beacon 106 may then perform Bluetooth beacon detection within the residence. In response to detecting a Bluetooth device when the resident is supposed to be absent, or detecting a change in Bluetooth activity, the sound beacon 106 may detect an alarm condition and trigger an alarm by flashing lights, playing a siren sound, communicating the alarm condition over WiFi or Z-Wave, and/or logging the occurrence of the event (such as at a cloud location).

Sound Beacon Operation with or without Hub

In one embodiment, the sound beacon 106 can operate with or without a hub or controller. For example, the sound beacon 106 may still provide audio playback, alarm, sensor data gathering, lighting, and/or other features in a system with only sound beacons 106 and a WiFi router or access point. However, other features, such as Z-Wave communication, may not be present without a central controller or hub.

### Notifications

The sound beacon 106 may provide notifications or alerts based on events. For example, the sound beacon 106 may include a text-to-speech engine or recorded audio notifications. In one embodiment, the sound beacon 106 may notify a user of any events with an alarm system, entertainment system, or may provide voice responses to instructions or questions. For example, the opening of a door detected by an alarm system may result in an audible “front door opened” message played on a sound beacon 106 located near a user. When a doorbell has been pressed, the sound beacon 106 may play “door bell pressed” or “doorbell detected.” Similarly, a command to “turn off the lights” may result in a response “all lights powered off” once the task has completed. In one embodiment, notifications may include notifications generated locally to a sound beacon or a controller, such as an alarm or entertainment controller. In another embodiment, notifications or responses may be provided by a cloud service. For example, voice commands may be forward to a cloud service, such as those available via Amazon or Google, and the responses to those voice commands may be played over a sound beacon 106. Following are a list of commands that may be spoken and processed: a command “what's the weather forecast for today” may result in a cloud service obtaining weather details and playing back a voice response; a command “turn off the lights” may result in an alarm service turning of the lights and the sound beacon 106 playing a voice response indicating that the lights have been turned off; the command “add gelato to my shopping list” may cause a cloud service to add the word “gelato” to a shopping list and playback a voice command that gelato has been added; the command “arm the alarm to stay mode” may cause the sound beacon 106 to cause an alarm system to enter stay mode; the command “set my alarm for 8:00 a.m. tomorrow morning” may cause a mobile device to set an alarm at the corresponding time; a command “play ‘Today's Hits’ station on Pandora” may cause a mobile device or cloud service to begin playing corresponding music on a sound beacon 106; a command “what is the square root of 579?” may cause a cloud service to process the request and play back a voice response with the answer.

### Lighting

The sound beacon 106 may also include one or more lights for indicating a system status, providing mood lighting, acting as a night light, or indicating an emergency or alarm. In one embodiment, lights are located on a surface that faces at least partially outward or toward a wall so that light is reflected off a wall on which the sound beacon 106 is mounted (see FIG. 16). For example, the lights may be mounted on a side panel (see FIG. 9) where the light is directed outward and towards a rear of the sound beacon 106. The lights (e.g., LED lights) may be configured to provide a plurality of different colors for indicating mood, status, or other information.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A device comprising:
a housing for housing one or more components, the one or more components comprising:
one or more speakers;
one or more wireless transceivers for communicating over a wireless network;
one or more microphones;
an audio processing device configured to receive audio from the one or more microphones and detect voice commands; and
a processing unit configured to, in response to the voice commands, trigger one or more of audio playback and a two-way voice call; and
a plug adapter configured to engage a wall outlet to receive power from the wall outlet and retain the device against a wall with respect to the wall outlet.

2. The device of claim 1, wherein the device further comprises wireless components that provide operability with a wireless standard for two-way voice communication, thereby allowing for communication with emergency personnel during an emergency scenario.

3. The device of claim 1, wherein the device further comprises an audio processor that is configured for processing voice commands or voice data received through the one or more microphones.

4. The device of claim 1, wherein the processing unit is configured to detect trigger words or trigger sounds to trigger operations by the device.

5. The device of claim 4, wherein a first trigger word initiates a query or voice command to a remote speech-to-text service and a second trigger word initiates a two-way voice call or room to room communication.

6. The device of claim 4, wherein the trigger sounds trigger an alarm signal to a hub, an alarm system controller, a siren, and/or flashing of lights.

7. The device of claim 1, wherein the device further comprises a multimedia processor that is configured for processing and/or streaming of audio data from a remote source or smart device to a speaker via a digital signal processor and an amplifier.

8. The device of claim 7, wherein the multimedia processor comprises a built-in WiFi radio and/or antenna for communicating with a WiFi router or node.

9. The device of claim 1, wherein commands are received from a mobile application executed on a smart device, an audio processor, and/or a multimedia processor to trigger audio playback from the smart device or cloud services implementing an audio video standard.

10. The device of claim 9, wherein voice responses from a cloud service are received and played back on the one or more speakers.

11. The device of claim 1, wherein device is configured to response to a wake word to trigger the device to listen and process voice controls.

12. The device of claim 11, wherein after detection of the wake word, the audio processor records, listens, and/or performs speech-to-text on subsequent words.

13. The device of claim 1, wherein the processing unit prioritizes each of a plurality of actions, wherein the processing unit receives an interrupt request number and each interrupt request number has a corresponding priority, wherein a higher priority item interrupts a lower priority item, but will not interrupt an item of the same or higher priority.

14. The device of claim 13, wherein a list of actions is ordered according to the following priority: emergency calls, alarms, phone calls, intercom communication, user voice commands, sensor data capture and storage, and audio/music playback.

15. The device of claim 1, wherein the device is configured to respond to an alarm condition by playing a siren sound or flashing lights.

16. The device of claim 15, wherein the processing unit causes an LED board to start flashing.

17. The device of claim 1, wherein the device participates in intercom communications with a second device, wherein the device receives audio from the second device and plays the received audio on the one or more speakers.

18. The device of claim 17, wherein the second device comprises a mobile app where a user can talk and the mobile app pushes sound captured by the second device via a WiFi node to the device.

19. The device of claim 18, wherein the audio comprises packets of audio data that include a header or identification indicating that audio data includes intercom communication.

20. The device of claim 1, wherein the device determines a location of one or more individuals within a room or home, wherein location detection is performed using one or more of a Bluetooth beacon, a movement detection system, a device detection system, or a heat detection system.
